(19) United States
(12) Patent Application Publication
(10) Pub. No.: US 2014/0291548 A1
(43) Pub. Date: Oct. 2, 2014

(54) FLUORESCENCE GAS AND LIQUID SENSOR

(71) Applicant: CROWCON DETECTION INSTRUMENTS LIMITED, Abingdon, Oxfordshire (GB)

(72) Inventors: Paul Basham, Abingdon (GB); Roger Hutton, Abingdon (GB)

(21) Appl. No.: 14/351,759

(22) PCT Filed: Oct. 11, 2012
(86) PCT No.: PCT/GB2012/052521

§ 371 Date: Apr. 14, 2014

(30) Foreign Application Priority Data
Oct. 12, 2011 (GB) 1117623.7

(51) Int. Cl. G01N 21/94; G01N 21/64

(52) U.S. Cl. CPC G01N 21/94; G01N 21/64
USPC 250/458.1

(57) ABSTRACT

An optical sensor for the detecting the presence of a gas or liquid comprising: a light source, a substrate, an active layer configured to emit light when illuminated by the optical light source and a detector; wherein the substrate and light source are arranged such that the majority or all of the light from the light source is reflected and/or refracted away from the detector and the detector is arranged to receive part of the light emitted by the active layer.

### TECHNICAL FIELD

The present invention relates to improvements in optical fluorescence fluid (gas and liquid) sensors. In particular, the invention relates to a low cost sensor that minimises or removes the need for optical filters in such sensors.

### BACKGROUND TO THE INVENTION

Optical based sensors for the measuring of the presence, or absence, of gasses such as oxygen, CO₂, carbon monoxide etc are known, and such sensors are commercially available.

Many commercially available optical based sensors are portable, as they need to be placed in areas of interest, such as mines. Such sensors may also be carried about a person's body when they enter hazardous locations.

Such sensors rely on a chemically coated layer present in the sensor which emits light when excited by an optical light source. The sensors can be based on luminescence such as fluorescence, photoluminescence and/or phosphorescence.

In such sensors an optical light source is used to excite the chemical layer, or active layer, which then emits light in a non-directional manner. The active layer is selected such that the amount of light emitted and the phosphorescence delay is dependent on the presence of a particular target species such as a gas. Therefore, by measuring the light emitted by the chemical layer a measure of the atmosphere in which the gas sensor is present can be made. In such commercially available systems, light sources such as lasers, LEDs, incandescent light sources etc may be used. The detectors used to detect the emission from the active layer may be any one of a number of commercially available detectors such as photodiodes. The component cost of such light sources and sensors can be relatively low.

However, a problem with known commercially available systems is that light emitted directly from the optical source, or stray light from within the sensor may be detected by the detector and “wash out” the signal from the active layer. In order to improve the signal intensity of the light emitted from the active layer, it is therefore desirable to eliminate such light through the use of optical filters such as band pass and notch filters. Such filters, in particular notch filters, however are typically expensive. The cost associated with the provision of the filters may in some circumstances represent a significant proportion of the cost of manufacturing an optical gas and/or liquid sensor.

FIG. 1 shows an example of the geometry typically used in commercially available portable sensors which require the use of filters. There is shown: an LED light source A; a first optical filter B; the active layer placed on a substrate C: a second optical filter D: and a photodiode sensor E. All the components are housed in a body F, thereby allowing the sensor to be easily transported and placed at a desired location(s).

In the geometry shown in FIG. 1, the LED A, filters B and D, substrate and active layer C and photodiode E are all positioned in alignment. In the example shown, the LED light source A emits at around 470 nm and the light passes through first filter B. The first filter B is a blue filter which has a cut off significantly below 600 nm (nanometres). This filtered light passes to the active layer and substrate C whereupon the active layer is excited, causing it to emit light, at a wavelength longer than 600 nm The emitted light from the active layer C and from the LED A then passes to the second filter D which has a wavelength cut off of approximately 600 nm. The light then proceeds to the photodiode detector E whereupon it is detected. Accordingly, as the light from the LED A is emitted at approximately 470 nm and transmitted through the filters B and been absorbed or reflected by the filter D, and the lights from the active layer C has a wavelength of greater than 600 nm, the light detected at the photodiode is accordingly above 600 nm i.e. only the light emitted from the active layer is detected. Therefore, the use of the two filters allows for the light emitted by the LED A to be filtered and separated from the light emitted by the active layer C. Whilst such an arrangement of filters is effective in ensuring that the detected light by the photodiode E is the light emitted by the active layer C, the cost associated with the filters B and D are typically high, and can be of the order of several pounds per unit to produce. Furthermore, the use of filters reduces the light throughput as the light is absorbed passes through the filters, thereby reducing the signal from the active layer.

Accordingly, an aspect of the invention is to at least mitigate some of the above problems, and there can be provided an optical sensor according to claim 1.

In an embodiment light is incident on the coating from a source which is (i) not in the field of view of the sensor and preferably (ii) not specularly reflected hence not seen by the detector. Light meets the coating at greater than the critical angle to the normal. This is achievable by use of prismatic optics or more simply by illumination of the sensing layer from within the window by light that has come from edge illumination of the window.

Advantageously, according to some embodiments the present invention obviates the need for expensive optical filters. By using a “backscatter” or “edge illumination” geometry, the light emitted by an LED does not directly illuminate the sensor used to detect the emission from the active layer, and accordingly only light from the active layer is detected. Advantageously, such an arrangement prevents the signal from the active layer from being washed out. Furthermore, the arrangement described herein are found to result in increased light in the active layer allowing for a greater signal strength and/or a longer lifetime of the sensor. The increased light throughput is a result of the longer path of light inside the active film due to improved geometry and due to there being no filter losses. The longer lifetime is a result of the system not requiring a strong light source to achieve the same output signal level.

In further embodiments, a low cost filter such as the commercially available LEE filters type 160 may be used to improve the signal to noise ratio from the active layer. In such embodiments, it is found that lower cost filters may be used (typically of the order of a couple of pence per unit) as compared to the filters which typically are used in the embodiments as shown in FIG. 1 (typically of the order of several pounds per unit).

### BRIEF DESCRIPTION OF THE FIGURES

Embodiments of the invention are now described, by way of example only, with reference to the accompanying drawing in which:

FIG. 1 is a schematic of the geometry used in the prior art;

FIG. 2 is a schematic of the geometry used in a first embodiment of the invention;

FIG. 3 is a schematic of the geometry used in a second embodiment of the invention;

FIG. 4 is an example of an optical gas sensor according to an embodiment of the invention.

### DETAILED DESCRIPTION OF AN EMBODIMENT

According to an aspect of the invention there is provided a portable optical gas sensor arrangement which detects the light emitted from the active layer of the optical gas sensor but advantageously does not detect the light emitted from the exciting light source. In particular, the arrangement described herein avoids the need for expensive optical filters, and in the preferred embodiments dispenses entirely with the requirement of optical filters. The active layer is typically composed of oxygen sensitive complexes such as platinum or ruthenium complexes. In an embodiment the active layer is ruthenium oxide (RuO₂). The sensor in an embodiment is portable thereby allowing it to be placed in a variety of different locations. In further embodiments the sensor is fixed. Furthermore, given that portable gas sensors are relatively inexpensive the present invention provides a lower cost device in which expensive filters are preferentially dispensed with,

The embodiments shown are able to measure the presence of gas in a fluid (i.e. a gas or liquid). The term gas detector is used interchangeably with a sensor which is able to detect the presence of a fluid (i.e. gas and/or liquid).

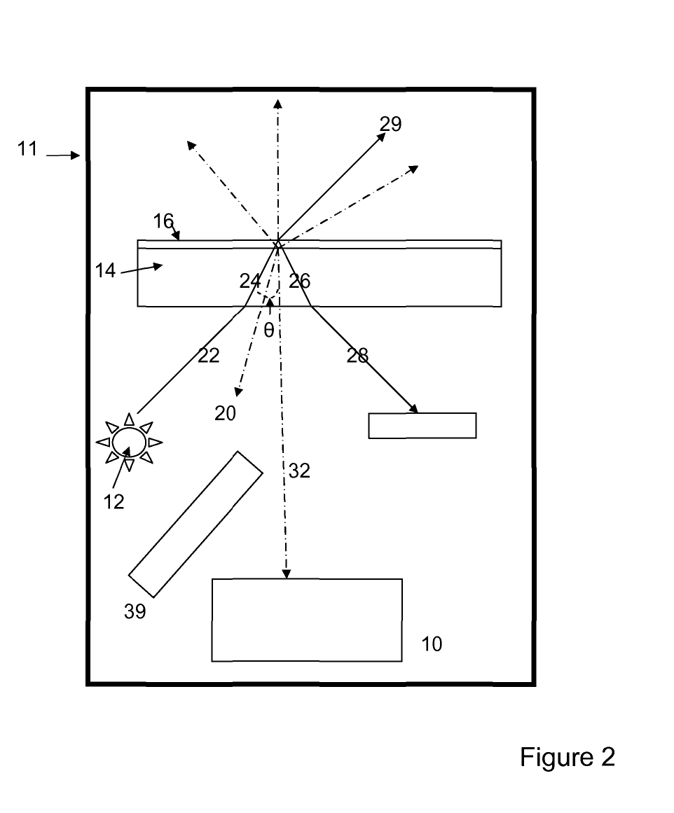

FIG. 2 shows a schematic representation of the geometry of the optical light sensor used in a portable, or fixed, gas sensor according to a preferred embodiment of the invention. This embodiment is named the “backscatter” embodiment in which the specular reflection of the light emitted from the optical light source is taken into account, and the photodiode is advantageously positioned away from the optical path of the specular reflection and is placed within the optical path of the light emitted by the active layer.

In FIG. 2 there is shown the photodiode detector 10, optical light source or LED 12, a substrate 14 on which the active layer is placed 16, the optical path of the light emitted from the LED 20, 22, 24, 26, 28, 29 and the light emitted by the active layer 30, 32, 34, 36, 38 (shown as dashed lines) and blockers 39. The detector 10 and the various components of the sensor (e.g. active layer 16 etc) are contained within a housing 11 thereby defining a portable, or fixed, fluid sensor. The housing 11 is made from a rugged material such as thermoplastics, and is arranged so as to be able to withstand the conditions typically associated with gas sensing environments. In other embodiments, other materials for the housing may be used.

The substrate 14 and active layer 16 define an element at least part of which emits light when illuminated by a light source.

The path of the light 20 emitted by the LED 12 travels in a straight line along a line 22 whereupon when it hits the substrate 14 due to the difference in refractive indices of air and the substrate the light beam 22 undergoes refraction to follow the line 24. As the light being 24 reaches the active layer 16, the light being undergoes specular reflection and follows the path 26, whereupon exiting the substrate 14 due to the change in the refractive index follows path 28. Some light is not reflected and exits the substrate following path 29.

Accordingly, the light emitted by LED 12 is directed along the paths 22, 24, 26 and 28. The light emitted by the active layer 16 however is emitted omnidirectionally 30, 32, 34, 36 and 38. In the absence of optical filters, using the particular backscatter geometry the majority of the light emitted by the LED 12 would potentially enter a detector 10 due to the specular reflection of the light within the substrate 14 and active layer 16.

To overcome the problem of the light from the LED entering the photodiode detector 10, the position of the photodiode detector 10 is chosen such that the light emitted by the active layer 16, may be detected by the detector whereas the specular light reflected from the LED 22 to 28 does not enter the detector 10. This is achieved by carefully selecting the relative positions of the LED 12, the active layer 16 and the detector 10. In particular, due to the omnidirectional emission of the active layer 16, the detector can be selectively positioned such that light from the LED 12 does not enter the detector but at least part, or portion, of the omnidirectional light emitted by the active layer 16, e.g. ray 32, enters the detector 10.

Therefore, the substrate and detector are arranged such that majority of the light from the LED is reflected or refracted away from the detector.

Such an arrangement beneficially removes the requirement for one or more optical filters to minimise or remove the impact of the emission from the LED 12. In a preferred embodiment in order to further reduce the level of specular reflection from the substrate 14 and active layer 16 of the light 20 emitted by the LED, an opaque material such as a black plastic 39 is placed to physically block the light from the LED and the specular reflection. The blocker 39 is constructed from a material which is therefore opaque to the light emitted by the LED 12 (or other illuminating source), and preferably to the specularly reflected light. Again, by taking advantage of the omnidirectional nature of the emission of the active layer, the opaque plastic is therefore positioned to blocks the majority of the emitted light 20 from the LED 12 whilst allowing a portion of the light from the active layer 16 to enter the detector 10.

The light emitted from the LED 22 will have an angle of incidence theta (θ) and depending on the angle θ the optimal position to place the detector varies as the specular reflected light 26, 28 will have a different path depending on the angle of incidence θ.

In a further the embodiment the light source, active layer and detector are arranged such that the light emitted from the light source is either reflected or refracted away from the detector. The detector is beneficially positioned to receive light from the active layer and not the light source. The casing of the sensor 11 also acts as the blocking elements to minimise and/or eliminate the stray light from the light source which may fall on the detector. In such an embodiment the optical gas sensor has a hard opaque outer casing made of a thermoplastic material. The sensor has a plurality of holes in the housing 11 in order to allow gas to enter and exit the casing allowing the atmosphere in which the sensor is placed may be sampled. In a preferred embodiment to minimise the amount of reflection from the LED light source from the walls of the sensor an aperture is placed in front of the LED light source to vignette the light. The photodiode detector is a commercially available BPW34 or similar low cost silicon photodiode detector which is mounted onto a PCB and connected to a processor and/or computing device. The processor and/or computer are configured, in a known manner, to determine the presence of a target gas in the atmosphere based on the light detected by the detector.

A portion of the light emitted from the active layer therefore travels towards the photodiode detector. In an embodiment a second optical filter is present to remove any light from the LED which has been scattered by the substrate. It is found that due to imperfections in the active layer and substrate (such as scratches) a small portion of light from the LED may be randomly scattered by the imperfections to the detector. Therefore, the second optical filter is optionally used to remove such randomly scattered light. As the amount of light scattered towards the detector is low the efficiency of the filters to remove the contribution from the LED can be low. Low efficiency filters are typically inexpensive.

In an embodiment, several detectors may be placed within an environment to be analysed with each detector coupled to a central computer and/or processor providing a detailed analysis of the presence or absence of a particular gas within an atmosphere. Furthermore, by changing the material used on the active layer, different gases may be detected. The LED light source may be pulsed or configured to emit several tens of times per second, allowing for a near instantaneous measure of the atmosphere due to the change in emission from the active layer.

Such an arrangement is found to have a signal level in excess of 200 mV after amplification. With no active coating present to interact with the light the totality of the 470 nm light is passed through to the other end of the window from the entry point. The implementation tested without an active coating results in a detected signal level below 20 mV.

Whilst the angle of incidence θ further increases it eventually becomes greater than the critical angle θ_{c} of the substrate 14 and the active layer 16. The critical angle θ_{c} changes according to the refractive index of the material used for the substrate and active layer. In the preferred embodiments the refractive indices of the substrate and active layer are such that total internal reflection occurs at the boundary of substrate or active with the atmosphere (or liquid) but not at the boundary of the substrate and active layer. The refractive index of the substrate and active layer are not necessarily identical but in practice are found to be similar. Accordingly, once the angle incidence θ becomes greater than the critical angle light reflected between the boundary of the substrate 14 and the atmosphere undergoes total internal reflection, and similarly light reflected between the boundary of the active layer 16 and the atmosphere undergoes total internal reflection, and accordingly no light is reflected from the substrate onto the detector. Such a geometry is called the “edge illumination geometry.”

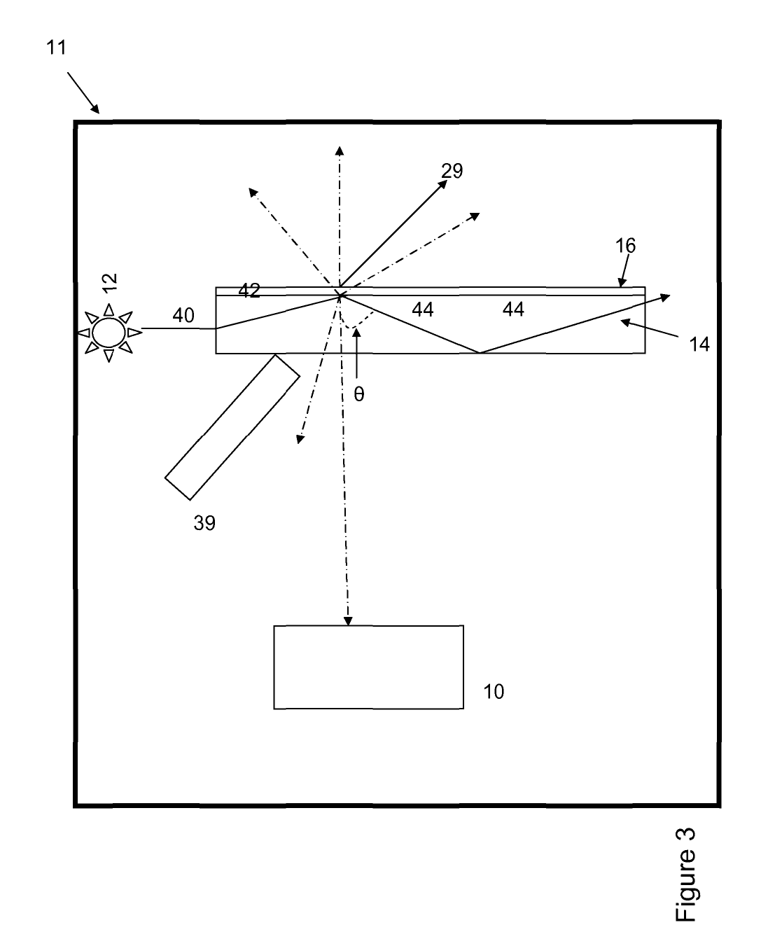

FIG. 3 shows a schematic representation of the edge illumination embodiment of the present invention. There is shown, photodiode detector 10, LED 12, incidence light 40, angle of incidence θ, reflected light 42, totally internally reflected light 44 and total internal reflection points R1 and R2. The detector is contained within a housing 11 thereby defining a portable, or fixed, fluid sensor. In the embodiment shown, the short wavelength light is totally internally reflected inside the window however the evanescent wave interacts with the coating and a proportion of the photons are absorbed to be re-emitted as phosphorescent light.

As with the embodiment shown in FIG. 2 the substrate and active layer define an element at least part of which emits light when illuminated by a light source.

As the emitted light 40 enters the substrate 14 the light is refracted. This LED light undergoes specular reflection with an angle of θ which is greater than the critical angle θ_{c} for the material of the active layer 16 at total internal reflection point R1. The light 44 continues through the active layer 16 and substrate 14 to the boundary of the substrate 14 and atmosphere at point R2. Again as the angle θ is greater than the critical angle θ_{c} of the substrate 14, all light is reflected within the substrate 14 and no light escapes to be detected by the sensing element 10. The reflected light carries on through the substrate 14 undergoing further total internal reflections at the active layer and substrate (not shown). Furthermore, as the light is incident on the active layer 16, the active layer 16 is excited and emits in an omnidirectional manner (shown as the dashed lines). Any light detected by the photodiode detector 10 therefore has originated from the active layer 16, as the specularly reflected light cannot escape the substrate due to total internal reflection (e.g. at points R1 and R2). Accordingly, the edge illumination geometry described allows for the detector 10 to be positioned in such a manner that no light from the LED 12 is received and only light from the active layer 16 is detected. Therefore, the substrate and detector are arranged such that all of the light from the LED is reflected away from the detector. In practice due to defects and impurities of the substrate a small amount of light from the LED may be randomly scattered towards the detector.

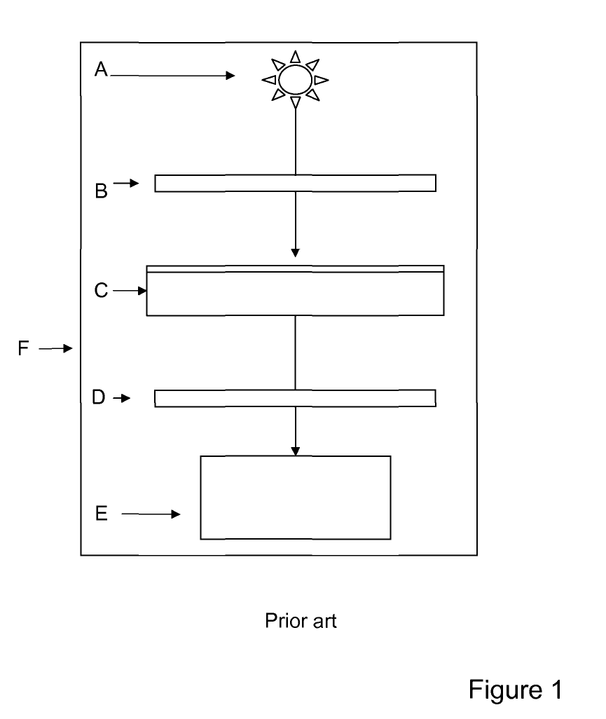

Unlike the transmission geometry, shown in FIG. 1, where the LED is visible to the detector the need for high end expensive filters is avoided as the geometry takes advantage of the refractive index of the substrate 14 and active layer 16 so as to ensure that only light from the active layer 16 is detected. Accordingly, the costs associated with such a geometry are greatly reduced.

Therefore, the backscatter and edge illumination embodiments shown function using the same principles and may be thought of as the same embodiment where the majority or all of the light from the light source is reflected or refracted away from the detector and a portion of the light from the active layer is detected by the detector. The nominal transition between both embodiments is when the angle of incidence is greater than the critical angle of the substrate on which the active layer is placed. When the angle of incidence of the light source is less than the critical angle then the sensor is a “backscatter” sensor, and when it is greater than the critical angle (and total internal reflection occurs) it is an “edge illuminated” sensor. Therefore at least 50%, more preferably 80% and even more preferably 95% to all of the light emitted by the light source is reflected away from the detector due to total internal reflection.

In an embodiment the system is arranged such that emitted light enters the edge of a 2 mm thick BK7 glass window which supports the active coating on the top face. The emitted light contacts the coating at an angle of approximately 80 to 85 degrees from the normal and the light photons either interact with the coating or be totally internally reflected internal to the window. Photons that do not interact with the coating proceed to the opposite edge of the window from their entry point and exit from the system. These photons do not impinge on the detector and therefore do not register. The detector is placed in close proximity with and parallel to the bottom face of the BK7 window, opposite the face supporting the coating. Light emitted by the coating is in any direction by virtue of the phosphorescence process. Therefore, a proportion of this light enters the detector and the arrangement thus ensures that the light detected by the detector originates from the coating and not the light source. Advantageously due to the increased path length of the light through the substrate the change of a collision with the active layer increases and accordingly the throughput increases. As the throughput increases the intensity of the light source can be reduced to achieve an acceptable signal thereby increasing the lifetime of the sensor as less energy is required.

In the embodiments shown in FIGS. 2 and 3 the active layer is shown as being placed or coated onto the substrate. In further embodiments the active layer (or material) may be incorporated in the substrate e.g. via doping.

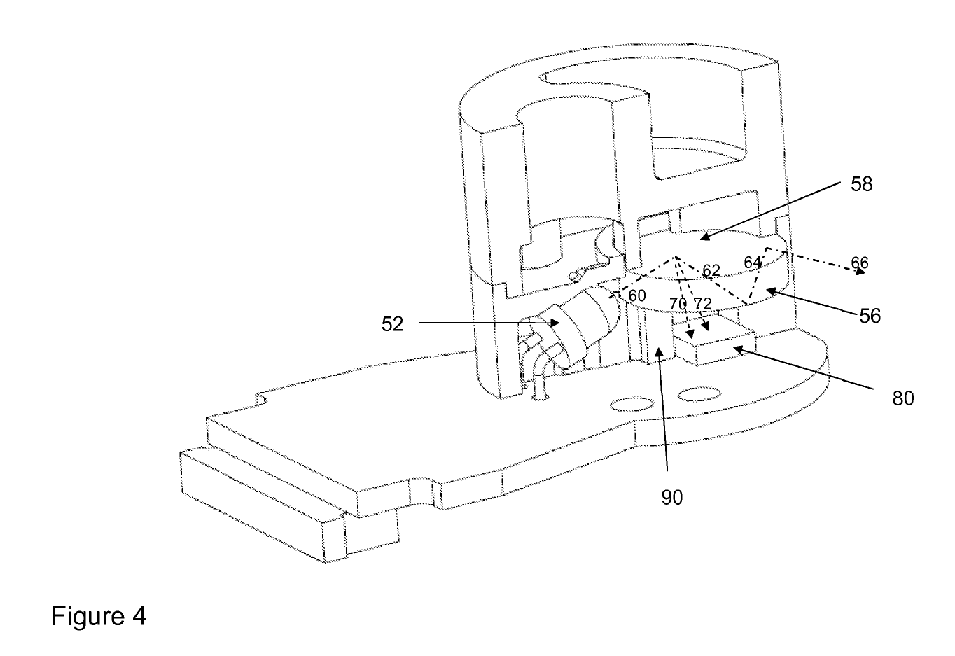

FIG. 4 shows an “edge illumination” embodiment of the invention as described in detail with reference to FIG. 3. There is shown the sensor 80; LED light source 52; first optical filter 54; apertures 51 and 53; substrate 56; active layer 58; light path of light emitted from LED 60, 62, 64, 66; light emitted from the active layer 70, 72 detector 80 and blocker 90. The components shown in FIG. 4 are contained within a housing to define the fluid detector (housing not shown for clarity).

The embodiment shown in FIG. 4 typically has a substrate 56 that is 2 mm high (in the y axis) and between 8 mm to 14 mm long (in the x axis). The substrate 56 is coated with an active layer 58 of RuO₂ of 1/50 mm in depth. The substrate material in the present example shown is glass and accordingly has a critical angle of approximately 61 degrees.

The light from the LED is emitted substantially along the length of the x-axis of the substrate. As the angle of incidence θ of the LED light is greater than the critical angle θ_{c}, the light undergoes total internal reflection and cannot escape the substrate. In the embodiment shown the LED 52 is positioned so that the angle of incidence for light emitted by the LED is approximately 70° which is greater than the critical angle of 61°. Therefore, the substrate and detector are arranged such that majority of the light from the LED is reflected away from the detector by total internal reflection.

Advantageously, in this embodiment as the light therefore travels the length of the x-axis of the substrate (whereas in the “backscatter” embodiment it travels substantially the length the y-axis) due to the increased path length the chance of an individual light photon impacting on and exciting molecules in the active layer is increased. Therefore, advantageously such an arrangement increases the throughput of the sensor. As the throughput is enhanced the ability of the sensor to detect changes in the composition is increased and therefore the accuracy of the sensor is also increased.

The sensor 50 has numerous ventilation holes (not shown) thereby exposing the substrate 56 and active layer 58 to the atmosphere to be tested. The sensor housing 50 in the embodiment shown is made of an opaque thermoplastic material. The LED light source 52 is positioned such that light from the LED passes through the aperture 51 and directly into the side of the substrate 56. The LED 52 is positioned such that the angle of incidence of the light emitted by the LED 52 is such that it is greater than the critical angle for the substrate material. In further embodiments the light from the LED 52 is directed onto the substrate through the use of prismatic optics.

As the angle of incidence is greater than the critical angle, the light enters the substrate along path 60 and undergoes total internal reflection and follows the path as shown by lines 62, 64. As the light has undergone total internal reflection, light emitted by the LED does not exit the substrate and accordingly does not impact onto the photodiode detector 80. As the light enters the substrate along path 60 it also excites the active layer 58 causing emission from the active layer. The emission from the active layer is omnidirectional and accordingly some of the omnidirectional light from the active layer 58 will impact onto the photodiode detector 80 (as shown by paths 70 and 72). In the embodiment shown, there is also provided a blocker 90 of a material opaque such as a piece of black thermoplastic, which prevents light from the LED light source impacting directly onto the detector 80.

Thus the arrangement shown in FIG. 4 beneficially ensures that the light emitted by the light source is reflected away from the detector and that at least part of the light emitted by the active layer is detected by the detector.

Furthermore, the sensor and detector 80 may be in communication with a central computer or server (not shown). The communication between the sensor can be wired or wireless using known wireless communication protocols such as IEE 802.11. Therefore, a system of a plurality of detectors can be installed in an area (for example a room) and the readings from the individual detectors 80 sent to the central computer/unit to determine the level of gas or liquid in an area. Advantageously, by selecting different sensors with different active layers the presence of multiple gases in the same area can be measured.

Optionally, a first or second filter may be placed between the LED light source and the photodiode detector in order to remove any stray light from the LED light source. (The filters are not shown in FIG. 5). As with the embodiment shown in FIG. 4, several of these detectors 50 may be placed within an atmosphere to be detected thereby allowing the detection of multiple gasses and/or the detection of gas in multiple areas.

Therefore, the described arrangement allows for a cheaper to produce sensor, where filters can be dispensed with entirely, or where a low cost filters are used to remove emission from the exciting light source. Furthermore, due to the increase in the path length of light along the active layer the change of photon collision is increased therefore increasing throughput, efficiency and accuracy. A further benefit is that as the throughout is increased the voltage supplied to the light source can be reduced thereby increasing the lifetime of the light source and the active layer.

In a further embodiment of both the “backscatter” and “edge” a pair of polarising filter may be used to filter the emission from the light source to ensure that the contribution from the light source is eliminated or minimised. In other embodiments a single filter may be used. In further embodiments optics such as prismatic optics are positioned between the light source and element/substrate to direct light and vary the angle of incidence of the light source.

1-20. (canceled)

21. A portable fluid detector for detecting a presence of at least one of a target gas and a target liquid, the fluid detector, comprising:
a housing;
a light source disposed in the housing;
an element disposed in the housing, the element including a substrate and an active layer configured to emit a light upon receiving a light from the light source;
an optical detector disposed in the housing and configured to detect the light emitted by the active layer;
wherein the substrate of the element and the light source are arranged relative to the optical detector such that at least a majority of the light from the light source is at least one of reflected away and refracted away from the optical detector by the substrate of the element; and
wherein the optical detector is arranged to receive a portion of the light emitted from the active layer of the element and is in communication with a processor, the processor configured to determine a measure of the at least one target gas and the target liquid based on the portion of the light emitted by the active layer of the element.

22. The fluid detector of claim 21, wherein the housing does not comprise an optical filter.

23. The fluid detector of claim 21, wherein the element and the light source are arranged relative to each other such that an angle of incidence of the light emitted by the light source and received by the element is greater than a critical angle of the element, thereby causing a total internal reflection of the light emitted by the light source onto the element.

24. The fluid detector of claim 22, wherein the element and the light source are arranged such that the angle of incidence of the light emitted by the light source onto the element is less than a critical angle of the element.

25. The fluid detector of claim 21, further comprising at least one material opaque to the emitted light and disposed in the housing, the at least one material positioned to block a portion of the light emitted by the light source.

26. The fluid detector of claim 21, wherein the optical detector is positioned at an angle approximately normal to the element.

27. The fluid detector of claim 21, wherein the substrate is one of quartz, glass and plastic.

28. The fluid detector of claim 21, wherein the active layer is composed of at least one oxygen sensitive complex including at least one of platinum complexes and ruthenium complexes.

29. The fluid detector of claim 21, wherein the element and optical detector are positioned such that at least 80% of the light from the light source is one of reflected away and refracted away from the detector.

30. The fluid detector of claim 21, further comprising a first filter configured to filter the light from the light source.

31. The fluid detector of claim 30, wherein the first filter is one of a gel filter and a polarising filter.

32. The fluid detector of claim 21, further comprising at least one aperture formed in the housing to direct the light from the light source.

33. The fluid detector of claim 21, wherein the housing has at least one hole formed thereon to expose the active layer to an atmosphere.

34. The fluid detector of claim 21, further comprising at least one of a wired communication link and a wireless communication link in communication with the optical detector.

35. The fluid detector of claim 21, wherein the active layer is disposed adjacent the substrate.

36. The fluid detector of claim 35, wherein the active layer is coated on the substrate.

37. The fluid detector of claim 21, wherein the active layer is one of disposed adjacent and coated on a portion of the substrate where the light from the light source is reflected from the substrate forming an angle of incidence, the angle of incidence is one of equal to the critical angle and greater than the critical angle.

38. A system for detecting the presence of a plurality of target gases and target liquids, comprising:
a plurality of fluid detectors each configured to detect the presence of at least one of a target gas and a target liquid, each of the fluid sensors comprising:
a housing;
a light source disposed in the housing;
an element disposed in the housing, the element including a substrate and an active layer configured to emit a light upon receiving a light from the light source;
an optical detector disposed in the housing and configured to detect the light emitted by the active layer;
wherein the substrate of the element and the light source are arranged relative to the optical detector such that at least a majority of the light from the light source is at least one of reflected away and refracted away from the optical detector by the substrate of the element; and
wherein the optical detector is arranged to receive a portion of the light emitted from the active layer of the element and is in communication with a processor, the processor configured to determine a measure of the at least one target gas and the target liquid based on the portion of the light emitted by the active layer of the element;
at least one of a wired communication link and a wireless communication link in communication with the optical detector; and
a central processor in communication with the gas detectors via the at least one of the communication link and the wireless link.

39. The system of claim 38, wherein the central processor is configured to determine a measure of the at least one of the target gas and the target liquid based on the portion of the light emitted by the active layer of the element of each of the fluid detectors.

40. The system of claim 38, wherein at least one of the fluid detectors is configured to detect at least one target gas and target fluid different from the other ones of the fluid detectors.
